(19) United States
(12) Patent Application Publication
(10) Pub. No.: US 2007/0250347 A1
(43) Pub. Date: Oct. 25, 2007

(54) Broker service and system architecture for health care data

(76) Inventors: Klaus Abraham-Fuchs, Erlangen (DE); Sultan Haider, Erlangen (DE); Georg Heidenreich, Erlangen (DE); Michael Mankopf, Mohrendorf (DE); Peter Joachim Heil, Forchheim (DE); Volker Wetekam, Marloffstein (DE)

Correspondence Address: BRINKS HOFER GILSON & LIONE, P.O. BOX 10395, CHICAGO, IL, 60610, US

(21) Appl. No.: 11/410,486

(22) Filed: Apr. 25, 2006

(51) Int. Cl. G06F 19/00

(52) U.S. Cl. 705/3

(57) ABSTRACT

A broker service facilitates the provision of health-related information to an interested third party. The broker enters into an agreement with one or more health care institutions to obtain at least some access to health-related information stored on a server. In response to a request by the third party, the broker may construct a search filter to find relevant information stored on the server. The broker then may forward at least some of the results to the third party. The broker may install a plug-in software program on the server to facilitate access to the health-related information and/or limit the information based on local health care regulations.

### BACKGROUND

The present embodiments relate to a broker service and system architecture for obtaining health-related information. The broker service may receive a request for clinical data from a third party, search for compliant data, and submit relevant data to the third party in response to the request.

In several situations, preprocessed or restricted clinical data may be of value for a third party. For example, data on the consumption of pharmaceutical products may be of value to a pharmaceutical company for purposes of market analysis, or to a pharmacy for logistics planning. In other cases, data concerning clinical outcomes or reports may be useful to a health insurance company or other health cost payor institution for benchmarking or planning purposes. Further, diagnostic data for identifying patients that are suitable to be included in a clinical study may be of value to a third party. Also, epidemiologic data may be of interest to support planning and decision-making in public health care administration institutions. Still many other situations are possible in which a third party may be interested in obtaining preprocessed, or restricted clinical data.

Some of the data listed above may be stored electronically in a health care information technology system, e.g., a hospital information system or electronic health cards. Data may be shared on a limited basis. For example, a search may be performed to identify patients that satisfy criteria for inclusion in a clinical study. In these and other applications, an interested third party has direct access to the clinical database being searched, and the target data to be analyzed is known in advance. However, direct access may be invasive or burdensome.

### BRIEF SUMMARY

By way of introduction, the preferred embodiments described below include methods and systems for the provision of health-related information to an interested third party using a broker service. The broker enters into an agreement with one or more health care institutions to obtain at least some access to health-related information stored on a server. In response to a request by the third party, the broker may search through information on the server and forward at least some of the results to the third party. By allowing a broker to mediate a data transfer between a health care institution and a third party, a relatively large data pool may be searched and improved results may be obtained.

In a first aspect, a method is disclosed for providing health-related information to a third party. The broker obtains at least partial access to health-related information generated or obtained by a health care institution and stored by the health care institution on a server. The broker receives a request for the health-related information from the third party and constructs a search filter that characterizes the type of data to be searched. The broker then obtains search results based on the parameters set by the search filter and forwards at least some of the results to the third party.

In a second aspect, a system for providing health-related information to a third party is disclosed. The system comprises a server for storing health-related information generated or obtained by a health care institution. A broker interface is configured to access at least some information stored on the server. In response to a request by a third party, the broker interface is operable to formulate a request for the health-related information. The system also comprises a plug-in module installed on the server and operable to limit access by the broker interface to at least some purely classified data stored on the server.

In further embodiments, the broker may obtain access to the health-related information of multiple health care institutions, thereby obtaining a search result from a larger data pool. Further, the search results obtained by the broker may be enhanced, e.g., electronically evaluated, before being forwarded to the third party.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a block diagram of one embodiment of a system architecture for obtaining health-related information using a broker service.

FIG. 2 is a block diagram of an alternative embodiment of a system architecture for obtaining health-related information using a broker service.

FIG. 3 is a block diagram of a further alternative embodiment for obtaining health-related information using a broker service.

FIG. 4 is a flow chart diagram showing one embodiment of a method for providing health-related information to a third party using a broker service.

### DETAILED DESCRIPTION OF THE DRAWINGS AND PRESENTLY PREFERRED EMBODIMENTS

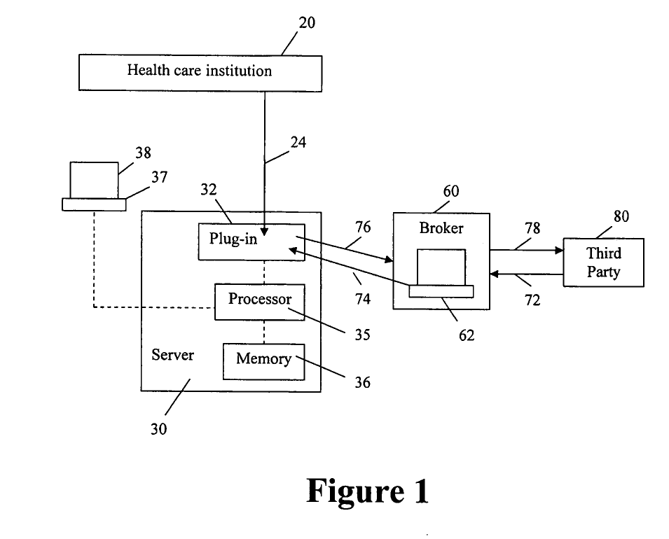

The present embodiments relate generally to a broker service for providing health-related information to an interested third party. Referring now to FIG. 1, a first embodiment of a broker service is described. A health care institution 20 may be any entity that generates or obtains preprocessed or classified health-related information, such as health care or clinical data. For example, the health care institution 20 may be a hospital, a doctor's office, a pharmacy, a testing center that performs clinical trials, or the like.

In the context of the present embodiments, the term “restricted” generally refers to health-related information that is not ordinarily obtained by the public. As an example, the complete records of a minor patient may not be divulged. However, some otherwise restricted information may be obtained by the public if identifying indicia are redacted and/or other legal requirements are met. For example, the age of the patient, medication and doses taken, and any adverse effects may be revealed. By contrast, the term “purely classified” relates to confidential information that, by law, cannot be divulged to the public.

The health care institution 20 comprises a system, or communicates with an external system, for storing health-related information. In one embodiment, the system comprises a server 30, a processor 35, a memory 36, a user input 37 and a display 38. Additional, different or fewer components may be provided. For example, the user input 37 and/or display 38 is not provided. The server 30 may be a personal computer, workstation, medical diagnostic imaging system, network, or other now known or later developed system for obtaining and storing information.

In the embodiment shown in FIG. 1, the server 30 is located external to health care institution 20, but is configured to receive a data stream 24 from the health care institution 20 over a network. The server 30 is operable to process, distribute and/or store the health-related information provided by the health care institution 20, as explained in greater detail below. Alternatively, the server 30 is at or in the health care institution 20. The server 30 is owned, leased or not owned by the health care institution 20.

The processor 35 is a general processor, digital signal processor, application specific integrated circuit, field programmable gate array, analog circuit, digital circuit, combinations thereof or other now known or later developed processor. The processor 35 may be a single device or a combination of devices, such as associated with a network or distributed processing. Any of various processing strategies may be used, such as multi-processing, multi-tasking, parallel processing or the like. The processor 35 is responsive to instructions stored as part of software, hardware, integrated circuits, film-ware, micro-code or the like.

The memory 36 is a computer readable storage media. Computer readable storage media include various types of volatile and non-volatile storage media, including but not limited to random access memory, read-only memory, programmable read-only memory, electrically programmable read-only memory, electrically erasable read-only memory, flash memory, magnetic tape or disk, optical media and the like. The memory 36 may be a single device or a combination of devices. The memory 36 may be adjacent to, part of, networked with and/or remote from the processor 35.

The user input 37 is a mouse, keyboard, switch, buttons, key, slider, knob, touch pad, touch screen, trackball, combinations thereof or other now known or later developed user input device. The user input 37 receives input from a user. In response to activation of the user input 37, signals or data are provided to the processor 35.

The display 38 is a CRT, monitor, flat panel, LCD, projector, printer or other now known or later developed display device for outputting determined information. For example, the processor 35 causes the display 38 at a local or remote location to output data indicating a possible diagnosis, a probability associated with one or more possible diagnoses, an image with marked locations of interest, or other medical decision assistance associated with the current patient record. The output may be stored with or separate from the patient record.

The memory 36 stores instructions for the processor 35. In one embodiment, the instructions are stored on a removable media drive for reading by the server 30. In another embodiment, the instructions are stored in a remote location for transfer through a computer network or over telephone lines to the server 30. The instructions also may be stored on other media or devices.

The memory 36 stores health-related information, such as a patient record. The patient record may be input manually via the user input 37, which may be located in the healthcare institution 20 or remotely. The patient record also may be input automatically at the health care institution 20. The patient record may be formatted or unformatted. The patient record resides in or is extracted from different sources or a single source. In one embodiment, the patient record is mined from other sources, such as described in U.S. Application Publication No. 2003/0130871, the disclosure of which is incorporated herein by reference.

The patient record stored includes variables available for a current patient record. The variables correspond to features, such as medical history, pain indication, lump indication, age, genetic information, test results, family history, billing codes, or other sources of information. The patient record may include one or more images of a same or different type, such as images input from ultrasound, MRI, nuclear medicine, x-ray, computer thermography, angiography, and/or other now known or later developed imaging modality. The processor 35, a different processor or the user may extract variables from the image. The variables correspond to features of the image. The images may be in any format, such as DICOM format with header information. Any now known or later developed patient record format, features and/or technique to extract features may be used.

In another embodiment, the memory 36 stores multiple patient records created as part of a clinical study or ongoing business at the health care institution 20. Alternatively, the patient records stored in the memory 36 may be collected from multiple health care institutions.

The health care institution 20 communicates with the server 30 and is able to send a stream of health-related information 24 to the server, as shown in FIG. 1. The server 30 may be located within the health care institution 20, or may be at a remote location. The server 30 may be a clinical workflow engine server in a hospital, an electronic patient record storage server, a server for processing clinical accounting data, a server for processing data flow from and to an electronic health card, or the like.

As will be apparent, multiple computers or workstations (not shown) may be located within a single health care institution 20, each having its own processor and memory. Each individual computer's memory may store different data, which may be transmitted to the server 30 via multiple streams 24. The server 30 may serve as a regional or central server for the health care institution 20.

The data transferred to the server 30 preferably is provided in one or more standardized formats, but may be unformatted (e.g., free text). The formats may comprise official standards, such as Digital Imaging and Communications in Medicine (DICOM) protocol, Health Level 7 (HL7) syntax, or International Classification of Diseases (ICD) code. Alternatively, the data format may be an internal format that meets the specific standards of the health care institution 20.

A search filter plug-in 32 is installed onto or remote from the server 30. The plug-in 32 may comprise a software program having instructions that are loaded into the memory 36 of the server 30, such that the software program may be run via the processor 35.

The software program of the plug-in 32 may be capable of various functions. For example, the plug-in 32 may be configured to process or index data stored on the server 30. As depicted in FIG. 1, data stream 24 is sent to the server 30, and before being stored in the memory 36, the data stream 24 is indexed to facilitate subsequent retrieval. The plug-in 32 also may be capable of searching through the information stored in the memory 36 in response to a search request, as explained in greater detail below.

The plug-in 32 may comprise software instructions, which may be installed in the memory 36, for tailoring search results to the rules and regulations of a particular geographical area, such as a state's medical confidentiality laws. The plug-in 32 also may be tailored to local rules and regulations, such as a hospital's confidentiality policy. Specifically, since the health-related information provided by the health care institution 20 may be restricted, the plug-in 32 is capable of reviewing the information to separate purely classified data from other data. The plug-in 32 is also capable of modifying restricted data, for example, by removing a patient's name or other identifying indicia.

By way of example, a patient record stored in the memory 36 may comprise the following variables: medical history, pain indication, age, genetic information, test results and family history, as well as an x-ray image. For this particular patient record, the test results and the family history may be considered purely classified information. The plug-in 32 may provide, as search results, the information relating to medical history, pain indication, age, and genetic information, along with the x-ray image. The test results and family history, which are considered purely classified, may be redacted, if possible, or else excluded from a search result.

Referring still to FIG. 1, a system architecture for a broker service is shown and will be described with respect to an interaction between the health care institution 20, a broker 60 and a third party 80. The broker 60 enters into a relationship with the health care institution 20 to obtain at least some access to the health-related information generated or obtained by the health care institution 20 and stored on the server 30. In one possible business arrangement, the broker 60 may share earnings received from the third party 80 with the health care institution 20 each time pertinent information is sent to the third party 80, as explained below. In an alternative arrangement, the broker 60 may pay the health care institution 20 a flat-fee to access the stream 24 of health-related information.

Either the health care institution 20, the broker 60 or another entity may own the server 30. If the health care institution 20 or another entity owns the server 30, a business relationship may be established between the owner of the server and the broker 60 to allow the broker 60 to install the plug-in software module 32 on the server 30.

If the broker 60 owns the server 30, he or she may install the plug-in 32 on the server and enter into an arrangement with a health care institution 20 to have its health-related information pass through the server. For example, the server 30 may be located directly on the broker's personal computer 62, in which case the health care institution 20 may send data streams 24 directly to the server on the broker's computer. Alternatively, the relationship is implemented with software or hardware to establish communications links.

The third party 80 may be interested in obtaining various health-related information through the broker 60. For example, the third party 80 may be an institution performing a clinical study and wishing to obtain diagnostic data for identifying patients who are suitable to be included in the study. Alternatively, the third party 80 may be a pharmacy or pharmaceutical company that wishes to obtain data on the consumption of pharmaceutical products, either for market analysis or for logistics planning. The third party 80 also may be health insurance company or other health cost payor institution that wishes to obtain data regarding clinical outcomes for benchmarking or planning purposes. The third party 80 also may be a public or governmental health care administration that wishes to obtain epidemiologic data to support planning and decision-making, for example, for purposes of providing public health care. The third party 80 may be another party having other interests in obtaining such health-related information.

The third party 80, wishing to obtain such information, therefore engages into a relationship with the broker 60. The third party 80 sends a request 72 to the broker 60 requesting general or specific information, which the broker 60 may or may not be able to access from the server 30. The request 72 may be verbal, written, in an electronic medium such as by e-mail, and so forth. Any number of financial or non-financial arrangements may be implemented between the broker 60 and the third party 80, such as having the third party 80 pay the broker 60 a flat fee per search request, or pay based on the number of search results obtained, and so forth.

Once the request 72 is received, the broker 60 may construct a set of search rules, or “search filter,” that sufficiently characterizes the data to be searched. Boolean, number, rule based, trained filters, classifier or other types of searching may be used. The broker 60 may own or access a computer 62 having a memory, a processor and a hard drive. The computer 62 may have software that allows the broker 60 to construct the search filter. When the broker 60 constructs the search filter, he or she may build a custom search filter using known or future-developed techniques. For example, the search filter may enable a user to input categories, such as gender, race, age, disease, and so forth. One or more pull-down boxes may be used in conjunction with one or more fill-in boxes.

In a preferred embodiment, the broker 60 knows the standardized data format that is used by the health care institution 20, for example, whether the data is in DICOM, HL7 and/or ICD codes. The broker 60 may learn of the data format used by the health care institution 20 at the time they enter into their business relationship to allow the broker 60 to access information on the server 30. Therefore, when the broker 60 constructs the search filter, the rules of the search filter may be compatible with the format of the health-related information stored on the server 30.

As an example, the third party 80 may request diagnostic information relating to a certain lung disease. The broker 60 constructs a search filter on the computer 62 from suitable ICD codes and/or DICOM header entries, depending on the format of the health-related information stored on the server 30. The search engine of the plug-in 32 then filters out appropriate data, such as words or images, in the data stored on the server 30.

In another example, the third party 80 may request information relating to an epidemic occurrence of a disease for purposes of detecting the disease at an early stage. The search filter may be constructed from a combination of ICD codes, DICOM header entries or HL7 message characteristics for the disease. The data stored on the server 30 is compared against this search filter.

The plug-in 32 may comprise a software module for a search engine that can receive any number of search filters. For example, the broker 60 may construct multiple simultaneous search filters, which may be accommodated by the search engine on the server 30. In another embodiment, multiple brokers, each of whom has a prior business relationship with the health care institution 20, may send simultaneous search filter queries to the plug-in 32 of the server 30. In each instance, the search engine is capable of comparing all of the data stored on the server 30 substantially simultaneously against each search filter.

Additionally, a search request software module may be installed on the broker's computer 62 to facilitate construction of the search filter. In this case, the data characteristics described by the third party 80 may be input into the search request software module, and the software module may forward the request to the plug-in 32 in the appropriate, standardized data format.

The plug-in 32 may also comprise software for restricting access to the information contained on the server 30. For example, the broker 60 may need to input a usemame and password into computer 62 to access the server 30 through the plug-in 32. Such a feature will prevent unauthorized retrieval of information from the health care institution 20.

As noted above, the plug-in 32 may modify or refine data that is provided by the server 30 to an outside source in the form of a search result 76. For example, the plug-in 32 may tailor the search results to limit data based on geographical rules and regulations. Therefore, the search result 76 returned to the broker 60 may not comprise the full set of relevant data stored in the memory 36. In particular, purely classified information may be withheld or modified, if possible, to conform to the appropriate rules and regulations before being divulged to the broker 60. Once the search is complete, the relevant search results 76 are transmitted to the computer 62 of the broker 60, and may be subsequently forwarded to the third party 80 by transmission 78.

The data returned to the broker 60 by the search result 76 may comprise tagged data. A unique tag may be applied to each request by the broker 60. When the search is successful and data is returned to the broker 60, the identified data may be retrieved at a later time by employing the assigned tag. Further, the data, or a link to the data, may be stored temporarily in a data file uniquely assigned to each successful request.

In another aspect, after search result 76 is yielded by the plug-in module 32, the content may be enhanced or altered before being delivered to the broker 60. For example, the search result data may be processed by an algorithm, such as a subsequent filter, evaluator, and the like. The algorithm may be installed in the memory 36 of the server 30 at the time the plug-in 32 is installed on the server, or by installing separate software for enhancing content on the server 30. By way of example, if the third party is interested in estimating the likelihood of breast cancer in Caucasian females ages 25-35 who are taking a certain medication, then a search filter may be constructed by the broker 60 to obtain raw data from the server 30. Before the raw data is returned to the broker 60, the algorithm may process the data and yield a correlation between the medication and incidence of breast cancer in such female population. The processed data, having enhanced content, then is returned to the broker 60 and may be forwarded to the third party 80. Alternatively, the enhancement algorithm may be installed on the broker's computer 62, or coupled externally to computer 62, such that the raw data may be enhanced after being delivered to the broker 60 but before being forwarded to the third party 80.

A threshold for a minimum number of required search results may be set by the third party 80. The third party 80 may be informed by the broker as soon as the threshold is surpassed. The fact that the number of search results exceeded the threshold may be the end result delivered to the third party, or the complete pool of data identified by the search filter may be delivered.

In an alternative embodiment, the entity from which information is obtained may not be a health care institution and may not provide health services. For example, a first broker may have previously obtained information from a health care institution. The first broker may share information with a second broker through a server associated with the first broker. In effect, a second broker's client may obtain information via multiple brokers.

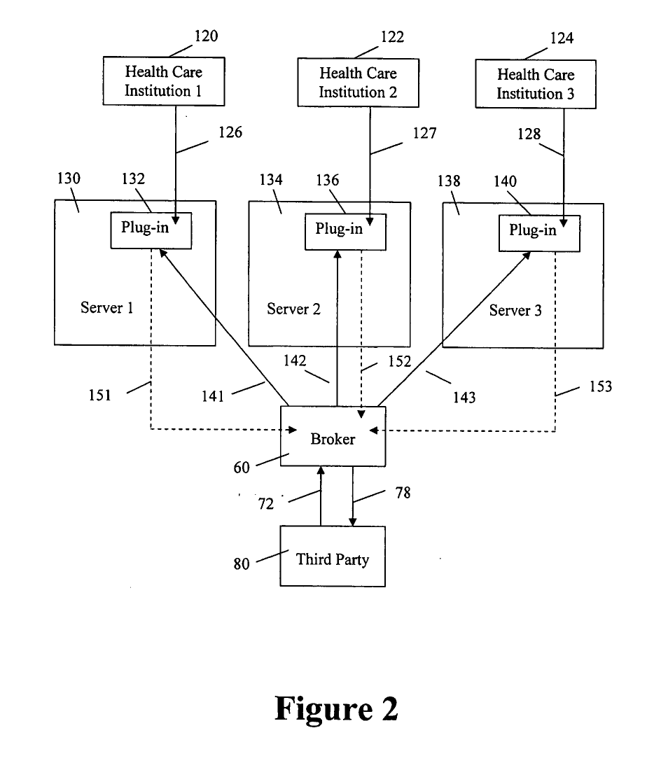

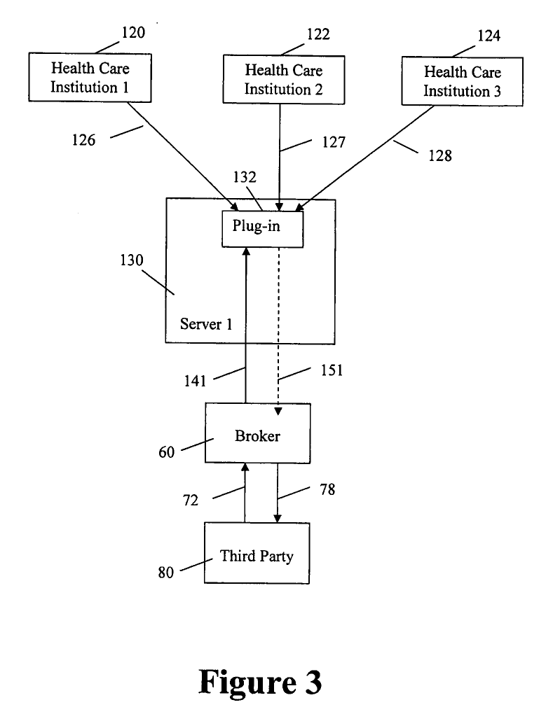

Referring now to FIGS. 2-3, alternative system architectures for a broker service are described for use with multiple health care institutions. In FIG. 2, the broker 60 has entered into a business relationship with three health care institutions 120, 122 and 124. While three institutions are depicted, any number may be used.

In the embodiment of FIG. 2, each health care institution has a dedicated server and plug-in module. Specifically, health care institution 120 sends data it has generated or obtained to server 130 via information stream 126. This information may be unique to health care institution 120, such as information regarding patients seen in a hospital, results of a clinical study performed at that institution, data regarding consumption of pharmaceutical products, or the like. Similarly, health care institutions 122 and 124 may transmit their unique streams 127 and 128 of health-related information to servers 134 and 138, respectively. Each of the servers 130, 134 and 138 preferably are provided in accordance with the server 30 of FIG. 1.

Three separate plug-in modules 132, 136 and 140 are installed on the servers 130, 134 and 138, respectively, and preferably are provided in accordance with the plug-in 32 of FIG. 1 above. The plug-in modules 132, 136 and 140 may be tailored for the rules and regulations of a particular geographical area. For example, in the embodiment of FIG. 2, it may be assumed that health care institutions 120, 122 and 124 are located in geographical locations subject to different confidentiality regulations. Therefore, like the embodiment of FIG. 1, the broker 60 enters into a relationship with each health care institution 120, 122 and 124 and tailors its respective plug-in module 132, 136 and 140 to the appropriate rules and regulations. In effect, the information obtained from the health care institution 120 may be more restricted than similar information requested and obtained from the health care institution 122.

In one exemplary method, the broker 60 has entered into business relationships with the health care institutions 120, 122 and 124 to obtain access to various health-related information. The third party 80, wishing to obtain such information, sends a request 72 to the broker 60 in a verbal, written or electronic medium. Once the request 72 is received, the broker 60 may construct a search filter that sufficiently characterizes the data to search for, as explained above with respect to FIG. 1. In a preferred embodiment, the broker 60 knows the standardized data formats that are used by the health care institutions 120, 122 and 124. If the health care institutions use different data formats, then the broker 60 may construct one or more different search filters 141, 142 and 143. For example, the broker 60 may construct search filters 141 and 142 from suitable ICD codes and/or DICOM header entries for health care institutions 120 and 122. The broker may construct another search filter 143 from a combination of ICD codes, DICOM header entries or HL7 message characteristics for health care institution 124. A search may be performed on just one or a sub-set of all servers or records.

Like the embodiment of FIG. 1, each separate plug-in 132, 136 and 140 may modify or refine data that is provided by the servers 130, 134 and 138 in the form of search results 151, 152 and 153, respectively. In particular, search results 151, 152 and 153 may be tailored to comply with the geographical or local rules and regulations of health care institutions 120, 122 and 124, respectively. Once the search is complete, the broker 60 may forward the relevant search results to the third party 80 by transmission 78. Optionally, the search results may be enhanced, e.g., electronically evaluated, before or after being forwarded to the broker 60 and before being transmitted to the third party 80.

In the embodiment of FIG. 3, the data transmission is similar to FIG. 2, with a main exception that health care institutions 120, 122 and 124 share a single server 130 having a plug-in module 132. In this embodiment, health care institutions 120, 122 and 124 may be situated in the same geographical area or the subject to the same confidentiality rules and regulations. Alternatively, the data from different institutions is labeled to allow application of different confidentiality standards by the plug-in 32. Data streams 126, 127 and 128 from the respective entities are forwarded to and stored in the same memory database of the server 130. The broker 60 may send a search request 141 to the server 130 and obtain the pertinent information in the form of search results 151. As explained above, plug-in module 132 may exclude or redact purely classified data that is stored on the server 130. Further, the search results may be enhanced, e.g., electronically evaluated, before or after being forwarded to the broker 60 and before being transmitted to the third party 80.

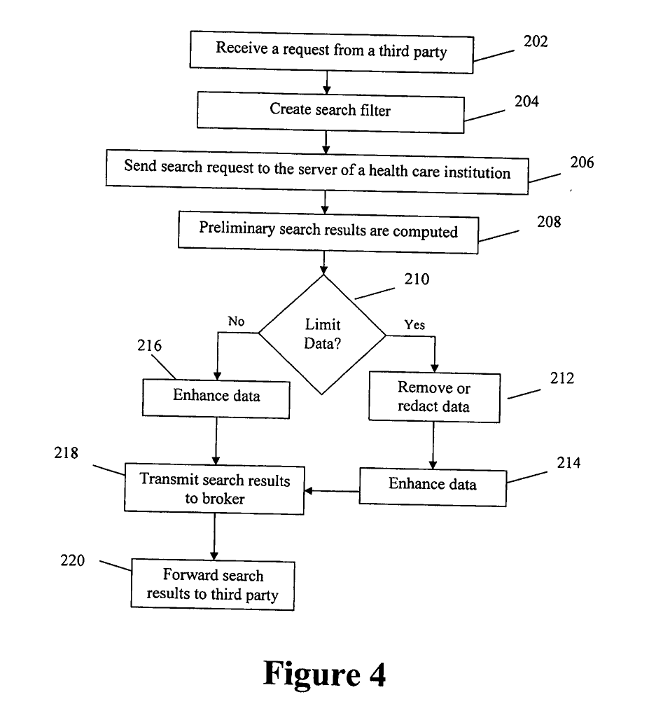

FIG. 4 shows a method for obtaining health-related information through a broker service. The method is implemented using the systems described above with respect to FIGS. 1-3 or a different system. Additional, different or fewer acts than shown in FIG. 4 may be provided. For example, acts 214 or 216 may not be performed. The acts are performed in the order shown or a different order. The acts may be performed automatically, manually, or combinations thereof.

A third party wishing to obtain health-related information engages into a relationship with a broker. The broker may have entered into a pre-existing relationship with one or more health care institutions, in order to gain at least some access to the data generated or obtained by the health care institution. The data generated or obtained by the health care institution may be stored on a server at the institution, or alternatively, on one or more remote servers. The pre-existing relationship allows the broker to access some or all of the data on the server(s). Alternatively, the broker enters into a relationship in response to the engagement.

In act 202, the third party sends a communication to the broker requesting health-related information. Upon receiving the request, in act 204 the broker creates a search filter for obtaining the desired information. The broker may construct a search filter that sufficiently characterizes the data to be searched. Preferably, the broker knows the standardized data format that is used by the health care institution, for example, whether the data is in DICOM, HL7 or ICD codes, to ensure that the rules of the search filter are compatible with the format of the health-related information stored on the server(s). In act 206, the broker sends out a search request to the one or more servers.

The server of the health care institution comprises a plug-in software module having search functionality. Specifically, the plug-in module is installed onto the server of the health care institution and may search and obtain results of information stored on the server. In act 208, the plug-in module performs the search and obtains preliminary results that meet the criteria of the search filter. The search results are “preliminary” because they may be subsequently refined by the plug-in. The preliminary search results may be in the form of words, images, videos or other media.

The plug-in may modify or refine data that is provided by the server(s) to an entity other than the health care institution, for example, to tailor the search results to geographical or local health care rules and regulations. In act 210, the plug-in determines whether the data contained in the search results must be limited. If so, then at act 212, the plug-in may remove or redact data. For example, purely classified information may be withheld and/or, identifying indicia may be removed before being revealed to the broker.

As noted above, the search results also may be enhanced, e.g., electronically evaluated. The search result enhancement may be performed at act 214 if the data set is limited by the plug-in, or at act 216 if the data is not limited. The data may be enhanced before being forwarded to the broker at act 218, as shown in FIG. 4. Alternatively, data may be enhanced after being sent to the broker but before being forwarded to the third party at act 220.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

We claim:

1. A method for providing health-related information to a third party, the method comprising:
obtaining at least partial access to health-related information generated or obtained by a health care institution and stored on a server;
receiving a request for health-related information from the third party;
constructing a search filter as a function of the health-related information;
obtaining search results based on parameters set by the search filter; and
forwarding at least some of the search results to the third party.

2. The method of claim 1 further comprising installing a plug-in software program on the server of the health care institution to facilitate access to the health-related information.

3. The method of claim 2 wherein the plug-in software program limits the search results based on local regulations.

4. The method of claim 3 wherein the plug-in software program removes identifying indicia from at least some data before the search results are obtained.

5. The method of claim 1 wherein constructing a search filter further comprises tailoring the search filter to be compatible with a known data format associated with the health-related information stored on the server.

6. The method of claim 1 further comprising enhancing data prior to forwarding the search results to the third party.

7. The method of claim 6 wherein enhancing the data comprises electronically evaluating the search results.

8. The method of claim 1 further comprising attaching a tag to the search results to permit subsequent retrieval of the search results.

9. The method of claim 1 further comprising storing information pertaining to multiple different health care institutions on the server.

10. A system for providing health-related information to a third party, the system comprising:
a server for storing health-related information generated or obtained by a health care institution;
a plug-in module installed on the server; and
a broker interface configured to access at least some information stored on the server, the broker interface being operable to formulate a search request for the health-related information in response to a request provided by the third party,
wherein the plug-in module limits access by the broker interface to at least some data stored on the server.

11. The system of claim 10 wherein the plug-in module is operable to provide search results to the broker interface in response to the search request.

12. The system of claim 10 wherein the broker interface is operable to construct a search filter compatible with a known data format associated with the health-related information stored on the server.

13. The system of claim 10 wherein the broker interface is operable to forward at least some of the search results to the third party.

14. The system of claim 10 wherein the server is located within the health care institution.

15. The system of claim 10 wherein the server is located remotely from the health care institution.

16. The system of claim 10 wherein the server comprises a memory operable to store health-related information pertaining to multiple health care institutions.

17. A method for mediating a transfer of health-related information between a health care institution and a third party using a broker service, the method comprising:
allowing a broker to obtain at least some access to the health-related information stored on a server;
allowing the broker to install a plug-in software program on the server; and
providing search results to the broker through the plug-in software program in response to a search request from a third party to the broker, the search results comprising at least some of the health-related information stored on the server.

18. The method of claim 17 wherein the plug-in software program limits the search results based on local regulations.

19. The method of claim 18 wherein the plug-in software program removes identifying indicia from at least some data before the search results are forwarded to the broker.

20. The method of claim 17 wherein the search request provided by the broker is tailored to be compatible with a known data format associated with the health-related information stored on the server.

21. The method of claim 17 further comprising enhancing data prior to forwarding the search results to the third party.

22. The method of claim 21 wherein enhancing the data comprises electronically evaluating the search results.

23. The method of claim 17 wherein the broker obtains health-related information from multiple health care institutions, the method further comprising installing a plug-in software program on a central server associated with the multiple health care institutions.
